(19) United States
(12) Patent Application Publication
(10) Pub. No.: US 2014/0375867 A1
(43) Pub. Date: Dec. 25, 2014

(54) IMAGE PICKUP APPARATUS CAPABLE OF CONTROLLING TRANSMITTANCE OF TRANSMITTANCE CHANGING MEMBER, METHOD OF CONTROLLING IMAGE PICKUP APPARATUS, AND STORAGE MEDIUM

(71) Applicant: CANON KABUSHIKI KAISHA, TOKYO (JP)

(72) Inventor: Hideo Kawahara, Kawaguchi-shi (JP)

(21) Appl. No.: 14/309,927

(22) Filed: Jun. 20, 2014

(30) Foreign Application Priority Data
Jun. 24, 2013 (JP) 2013-131611

(51) Int. Cl. H04N 5/238

(52) U.S. Cl. CPC H04N 5/238
USPC 348/335

(57) ABSTRACT

An image pickup apparatus that is capable of reducing changes in characteristics of a transmittance changing member. The image pickup apparatus includes an image pickup device, an optical unit for forming an object image on the image pickup device, and a physical stop that is provided between the optical unit and the image pickup device and is capable of changing a transmittance thereof with which incident light is transmitted therethrough. A reduced light amount by the physical stop is calculated. The transmittance of the physical stop is controlled using the calculated reduced light amount such that a change in characteristics of the physical stop beyond an acceptable level is not caused by heat generated by absorption of light incident from the optical unit by the physical stop.

### BACKGROUND OF THE INVENTION

1. Field of the Invention

The present invention relates to an image pickup apparatus that is capable of controlling the transmittance of a transmittance changing member, a method of controlling the same, and a storage medium.

2. Description of the Related Art

There has been proposed a technique of disposing an array of a plurality of elements of a panel the light transmittance of each of which can be controlled, in front of an image pickup device, providing a drive unit capable of reducing the transmittance of each element at any desired part of the panel, and thereby drivingly controlling a desired dot (see e.g. Japanese Patent Laid-Open Publication No. H09-51484).

By performing this driving control, even if a high-luminance part exists, it is possible to mask the high-luminance part, and brightly photograph a dark part by reducing the transmittance of dots corresponding to the high-luminance part. Such panel elements are generally called a physical stop.

However, in the technique disclosed in Japanese Patent Laid-Open Publication No. H09-51484, each cell of the physical stop which is variable in the amount of light transmission therethrough and each light receiving cell of the image pickup device are required to coincide with each other in optical position, which requires the physical stop to be arranged close to the front of the image pickup device.

On the other hand, a light receiving surface of the image pickup device is arranged at a location at which an object image is formed by an image pickup optical system, and hence a large amount of light is converged in a case where a high-luminance object image, such as the sun, is brought into focus on the image pickup surface.

Therefore, if the transmittance of the physical stop arranged at the light converged position is reduced, absorbed light is converted to heat, which changes the characteristics of the physical stop or deteriorates the material itself due to a temperature rise.

As for the temperature rise caused in the physical stop, assuming that the opening diameter of a lens is 7 cm (lens opening area=approximately 38.5 cm²) and the solar constant is approximately 2 cal/cm²/min, heat of 38.5×2=77 cal/min is generated.

Although a glass material, an electrochromic material, and a liquid crystal material, which form the physical stop, are different in specific heat from each other, the specific heat of the glass material, or the glass material and the liquid crystal material, which occupies or occupy a large proportion of the volume of the physical stop, is approximately 0.1 to 0.2 cal/g/° C.

If the transmittance of the physical stop is set to 50%, the temperature rise per minute will become 77÷(0.1 to 0.2)×0.5=385 to 192.5° C./g.

Although in actuality, heat is diffused through the glass material, air, etc., air and the glass material are sufficiently smaller in thermal conductivity than e.g. metal, and if conversion of the solar light is continued for a long time period, it is considered that the temperature would further rise.

This temperature rise in the glass material, the liquid crystal material, or the electrochromic material adversely affects density variation characteristics, and in a case of the liquid crystal material, for example, if the temperature becomes high, this may cause a decrease in contrast due to reduction of a transmittance variation range caused by deterioration of a polarization degree, or deformation or flaking of a polarizing plate.

Further, as for the electrochromic material as well, it is considered that there occurs generation of bubbles due to heat or a change in response time or the like due to oxidation-reduction reaction or the like, whereby it is impossible to perform proper control.

### SUMMARY OF THE INVENTION

The present invention provides an image pickup apparatus that is capable of reducing changes in characteristics of a transmittance changing member, a method of controlling the same, and a storage medium.

In a first aspect of the present invention, there is provided image pickup apparatus comprising an image pickup device, an optical unit configured to form an object image on the image pickup device, a transmittance changing member that is provided between the optical unit and the image pickup device, and is configured to be capable of changing a transmittance with which the transmittance changing member transmits therethrough light to be incident on the image pickup device from the optical unit, a calculation unit configured to calculate a reduced light amount by which the light to be incident on the image pickup device from the optical unit is reduced by the transmittance changing member, and a control unit configured to control the transmittance of the transmittance changing member using the reduced light amount calculated by the calculation unit such that heat generated by the transmittance changing member absorbing light incident thereon from the optical unit does not cause a change in characteristics of the transmittance changing member beyond an acceptable level.

In a second aspect of the present invention, there is provided an image pickup apparatus comprising an image pickup device, an optical unit configured to form an object image on the image pickup device, a diaphragm configured to limit an amount of incident light, a transmittance changing member that is provided between the optical unit and the image pickup device, and is configured to be capable of changing a transmittance with which the transmittance changing member transmits therethrough light to be incident on the image pickup device from the optical unit, a calculation unit configured to calculate a reduced light amount by which the light to be incident on the image pickup device from the optical unit is reduced by the transmittance changing member, and a diaphragm control unit configured to control, when the reduced light amount calculated by the calculation unit becomes not smaller than a predetermined value set in advance so as to prevent a change in characteristics of the transmittance changing member beyond an acceptable level from being caused by the transmittance changing member absorbing light incident thereon from the optical unit, the diaphragm such that the reduced light amount is made constant.

In a third aspect of the present invention, there is provided a method of controlling an image pickup apparatus including an image pickup device, an optical unit configured to form an object image on the image pickup device, and a transmittance changing member that is provided between the optical unit and the image pickup device, and is configured to be capable of changing a transmittance with which the transmittance changing member transmits therethrough light to be incident on the image pickup device from the optical unit, the method comprising calculating a reduced light amount by which the light to be incident on the image pickup device from the optical unit is reduced by the transmittance changing member, and controlling the transmittance of the transmittance changing member using the reduced light amount calculated by said calculating such that heat generated by the transmittance changing member absorbing light incident thereon from the optical unit does not cause a change in characteristics of the transmittance changing member beyond an acceptable level.

In a fourth aspect of the present invention, there is provided a method of controlling an image pickup apparatus including an image pickup device, an optical unit configured to form an object image on the image pickup device, a diaphragm configured to limit an amount of incident light, and a transmittance changing member that is provided between the optical unit and the image pickup device, and is configured to be capable of changing a transmittance with which the transmittance changing member transmits therethrough light to be incident on the image pickup device from the optical unit, the method comprising calculating a reduced light amount by which the light to be incident on the image pickup device from the optical unit is reduced by the transmittance changing member, and controlling, when the reduced light amount calculated by said calculating becomes not smaller than a predetermined value set in advance so as to prevent a change in characteristics of the transmittance changing member beyond an acceptable level from being caused by the transmittance changing member absorbing light incident thereon from the optical unit, the diaphragm such that the reduced light amount is made constant.

In a fifth aspect of the present invention, there is provided a non-transitory computer-readable storage medium storing a computer-executable program for executing a method of controlling an image pickup apparatus including an image pickup device, an optical unit configured to form an object image on the image pickup device, and a transmittance changing member that is provided between the optical unit and the image pickup device, and is configured to be capable of changing a transmittance with which the transmittance changing member transmits therethrough light to be incident on the image pickup device from the optical unit, wherein the method comprises calculating a reduced light amount by which the light to be incident on the image pickup device from the optical unit is reduced by the transmittance changing member, and controlling the transmittance of the transmittance changing member using the reduced light amount calculated by said calculating such that heat generated by the transmittance changing member absorbing light incident thereon from the optical unit does not cause a change in characteristics of the transmittance changing member beyond an acceptable level.

In a sixth aspect of the present invention, there is provided a non-transitory computer-readable storage medium storing a computer-executable program for executing a method of controlling an image pickup apparatus including an image pickup device, an optical unit configured to form an object image on the image pickup device, a diaphragm configured to limit an amount of incident light, and a transmittance changing member that is provided between the optical unit and the image pickup device, and is configured to be capable of changing a transmittance with which the transmittance changing member transmits therethrough light to be incident on the image pickup device from the optical unit, wherein the method comprises calculating a reduced light amount by which the light to be incident on the image pickup device from the optical unit is reduced by the transmittance changing member, and controlling, when the reduced light amount calculated by said calculating becomes not smaller than a predetermined value set in advance so as to prevent a change in characteristics of the transmittance changing member beyond an acceptable level from being caused by the transmittance changing member absorbing light incident thereon from the optical unit, the diaphragm such that the reduced light amount is made constant.

According to the present invention, it is possible to reduce changes in characteristics of the transmittance changing member.

Further features of the present invention will become apparent from the following description of exemplary embodiments (with reference to the attached drawings).

### BRIEF DESCRIPTION OF THE DRAWINGS

FIG. 1 is a schematic block diagram of an image pickup apparatus according to a first embodiment of the present invention.

FIG. 2 is a flowchart of a physical stop control process executed by a controller appearing in FIG. 1.

FIG. 3A is a graph showing a relationship between an incident light amount on a physical stop, a received light amount by an image pickup device, and a reduced light amount by the physical stop.

FIG. 3B is a graph showing a relationship between the incident light amount on the physical stop and a transmittance of the physical stop.

FIG. 4 is a schematic block diagram of an image pickup apparatus according to a second embodiment of the present invention.

FIG. 5 is a flowchart of a diaphragm control process executed by the controller appearing in FIG. 4.

FIG. 6A is a graph showing a relationship between an incident light amount on the physical stop, a received light amount by the image pickup device, and a reduced light amount by the physical stop.

FIG. 6B is a graph showing a relationship between the incident light amount on the physical stop and a transmittance of the physical stop.

FIG. 7 is a flowchart of a physical stop control process executed by the controller appearing in FIG. 1.

FIG. 8 is a diagram showing changes in temperature of the physical stop appearing in FIG. 1.

FIG. 9A is a graph showing a relationship between an incident light amount on the physical stop, a received light amount by the image pickup device, and a reduced light amount by the physical stop.

FIG. 9B is a graph showing a relationship between the incident light amount on the physical stop and a transmittance of the physical stop.

### DESCRIPTION OF THE EMBODIMENTS

The present invention will now be described in detail below with reference to the accompanying drawings showing embodiments thereof.

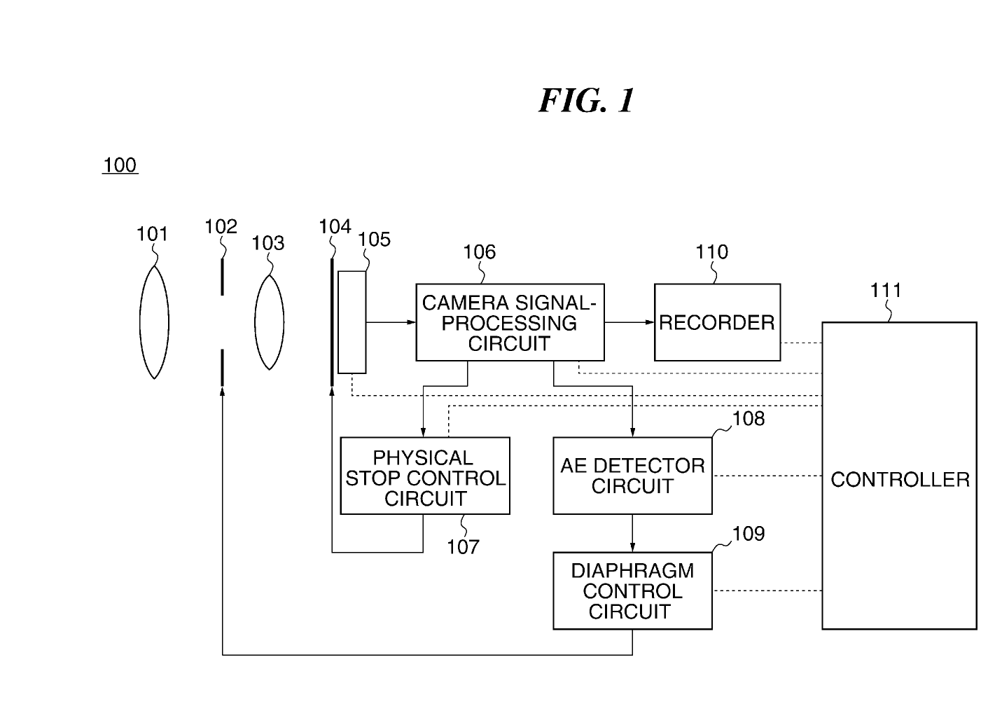

FIG. 1 is a schematic block diagram of an image pickup apparatus 100 according to a first embodiment of the present invention.

Referring to FIG. 1, the image pickup apparatus 100 comprises lenses 101 and 103, a diaphragm 102, a physical stop 104, an image pickup device 105, a camera signal-processing circuit 106, a recorder 110, a physical stop control circuit 107, an AE (auto exposure) detector circuit 108, a diaphragm control circuit 109, and a controller 111.

An optical unit including the lenses 101 and 103, and the diaphragm 102 causes an object image to be formed on the image pickup device 105, and the diaphragm 102 is disposed within a lens barrel, not shown, to control an incident light amount from the lens 101.

The image pickup device 105 is configured to photoelectrically convert an image formed by the lenses 101 and 103, and is implemented e.g. by a CMOS sensor. The physical stop 104, which is a transmittance changing member, is provided between the optical unit and the image pickup device 105, and is capable of changing a transmittance with which the physical stop 104 transmits therethrough light to be incident on the image pickup device 105 from the optical unit. The physical stop 104 is disposed in front of the image pickup device 105, and is made of a liquid crystal material or an electrochromic material, and the like.

The camera signal-processing circuit 106 is a circuit for converting an image pickup signal photoelectrically converted by the image pickup device 105 e.g. to a standard video signal. The recorder 110 is formed e.g. by an image memory for recording the standard video output signal obtained by the camera signal-processing circuit 106.

The AE detector circuit 108 is a circuit for performing detection processing on a luminance signal obtained by the camera signal-processing circuit 106 for aperture control. The diaphragm control circuit 109 is a circuit for generating a drive signal for controlling the diaphragm 102 such that a luminance value becomes equal to a predetermined target luminance value, based on a detected signal generated by the AE detector circuit 108.

The physical stop control circuit 107 is a circuit for controlling the transmittance of the physical stop 104, based on the luminance signal generated by the camera signal-processing circuit 106. Particularly, the physical stop control circuit 107 in the present embodiment corresponds to a control unit configured to control the transmittance of the physical stop such that characteristics of the physical stop are not changed by heat generated due to absorption of light incident from the optical unit by the physical stop. Note that controlling the transmittance of the physical stop such that characteristics of the physical stop are not changed includes controlling the same such that characteristics of the physical stop are changed within an allowable range of levels. That is, controlling the transmittance of the physical stop such that characteristics of the physical stop are not changed is intended to mean controlling the same such that characteristics of the physical stop are not changed in excess of the allowable range of levels. This also applies to other embodiments, described hereinafter.

The controller 111 comprises a CPU, a ROM, and a RAM, none of which is shown, and controls the overall operation of the image pickup apparatus 100, including operations of the image pickup device 105, the camera signal-processing circuit 106, the recorder 110, the physical stop control circuit 107, the AE detector circuit 108, and the diaphragm control circuit 109.

Next, a method of calculating the transmittance of the physical stop 104, used in the present embodiment, will be described. First, in the present embodiment, the physical stop control circuit 107 controls the transmittance of the physical stop 104 on a cell-by-cell basis based on a luminance signal of each pixel obtained by the camera signal-processing circuit 106.

In the transmittance calculation method, it is only required to set a transmittance inversely proportional to a received light amount by the image pickup device 105, and in the present embodiment, the transmittance ND of the physical stop is calculated by the following equation (1):

ND=1/(1+E·k) (1)

wherein E represents a received light amount by the image pickup device 105 per unit time, and k represents a constant which can be determined by a maximum value of the incident light amount and a maximum transmittance change amount. For example, assuming that the maximum value Emax of an assumed incident light amount is 400% and the maximum transmittance change amount NDreng of the physical stop is 50%, k can be determined by the following equation:

$$\begin{matrix}k = 1 / ( E max \cdot NDreng ) \\ = 1 / ( 400 \times 0.5 ) \\ = 1 / 200\end{matrix}$$

Note that although the relationship between the received light amount by the image pickup device 105 per unit time and the luminance signal obtained by the camera signal-processing circuit 106 is non-linear in a range where the received light amount is large because of saturation of the image pickup device 105, in the present embodiment, the relationship in the range is assumed to be linear.

Next, since a reduced light amount NDlos, which is a light amount by which the received light amount is reduced per unit time by the physical stop 104, due to a change in the transmittance of the physical stop 104, is an amount of light reduced by the physical stop 104, and hence in the present embodiment, the reduced light amount NDlos is calculated by the following equation (2):

NDlos=Ein−E (2)

wherein Ein represents an incident light amount on the physical stop 104 per unit time, and E represents a received light amount by the image pickup device 105 per unit time.

Further, based on the received light amount E by the image pickup amount 105 and the transmittance ND of the physical stop, the incident light amount Ein on the physical stop 104 can be calculated by the following equation (3):

Ein=E·(1/ND) (3)

From the above equations (2) and (3), it is possible to obtain the following equation (4):

NDlos=E·(1/ND)−E (4)

By transforming the equation (4) with respect to the transmittance ND, it is possible to obtain the following equation (5):

ND=E/(NDlos+E) (5)

Note that the temperature rise of the physical stop 104 is different depending on the conditions of properties (specific heat, thermal conductivity, weight) of a material forming the physical stop 104, a shape (surface area) thereof, ambient temperature (temperature, specific heat, thermal conductivity, etc. of adjacent members), an absorbed light amount, a light receiving position, etc.

Therefore, to determine a change in characteristics of the physical stop 104, it is necessary to measure the temperature rise by using parameters indicative of other factors than the shape, the material, and the like the conditions of which are fixed.

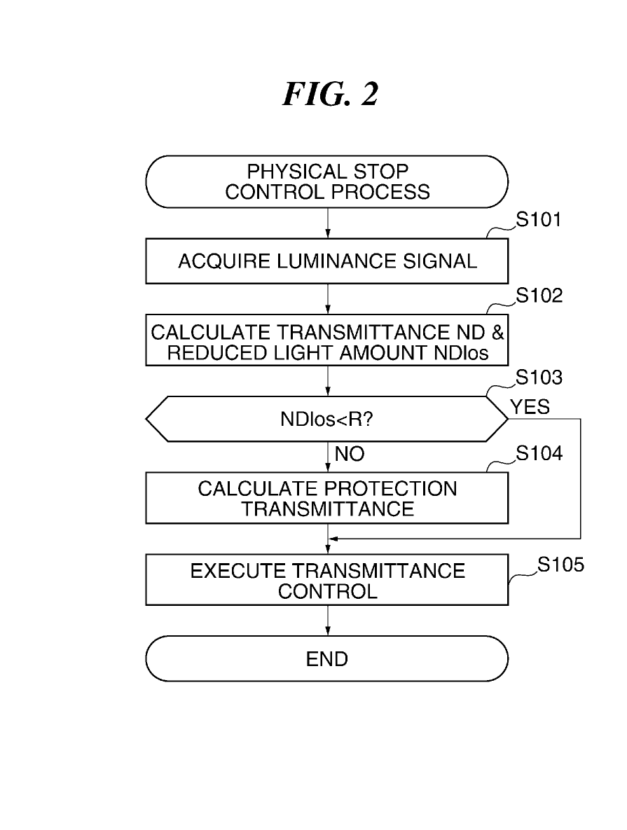

FIG. 2 is a flowchart of a process for controlling the physical stop 104, which is executed by the controller 111 appearing in FIG. 1.

The process for controlling the physical stop 104 is repeatedly executed e.g. at synchronization timing of a video vertical synchronization signal.

Referring to FIG. 2, the physical stop control circuit 107 acquires a luminance signal from the camera signal-processing circuit 106 (step S101).

Then, the controller 111 determines the received light amount E by the image pickup device 105 per unit time from the luminance signal acquired by the physical stop control circuit 107, calculates the transmittance ND of the physical stop 104 using the equation (1), and further, calculates the reduced light amount NDlos using the equation (4) (step S102). The step S102 corresponds to the operation of a calculation unit configured to calculate a reduced light amount by which the incident light amount on the image pickup device from the optical unit is reduced by the physical stop.

Then, the controller 111 determines whether or not the reduced light amount NDlos is less than a predetermined value R which is set in advance (step S103). The predetermined value R is a value for determining whether or not the reduced light amount is an amount which has no influence on the change of characteristics even when the reduced light amount is continued which is, in other words, an amount of reduced light converted to heat by the physical stop 104.

If it is determined in the step S103 that the reduced light amount NDlos is less than the predetermined value R (YES to the step S103), the controller 111 causes the physical stop control circuit 107 to control the transmittance of the physical stop 104 such that it becomes equal to the calculated transmittance ND (step S105), followed by terminating the present process.

On the other hand, if it is determined in the step S103 that the reduced light amount NDlos is not less than the predetermined value R (NO to the step S103), the controller 111 substitutes R in the reduced light amount NDlos in the equation (5) to thereby calculate a protection transmittance ND which is a transmittance for protecting the physical stop 104 (step S104).

Then, the controller 111 causes the physical stop control circuit 107 to control the transmittance of the physical stop 104 such that it becomes equal to the calculated protection transmittance (step S105), followed by terminating the present process.

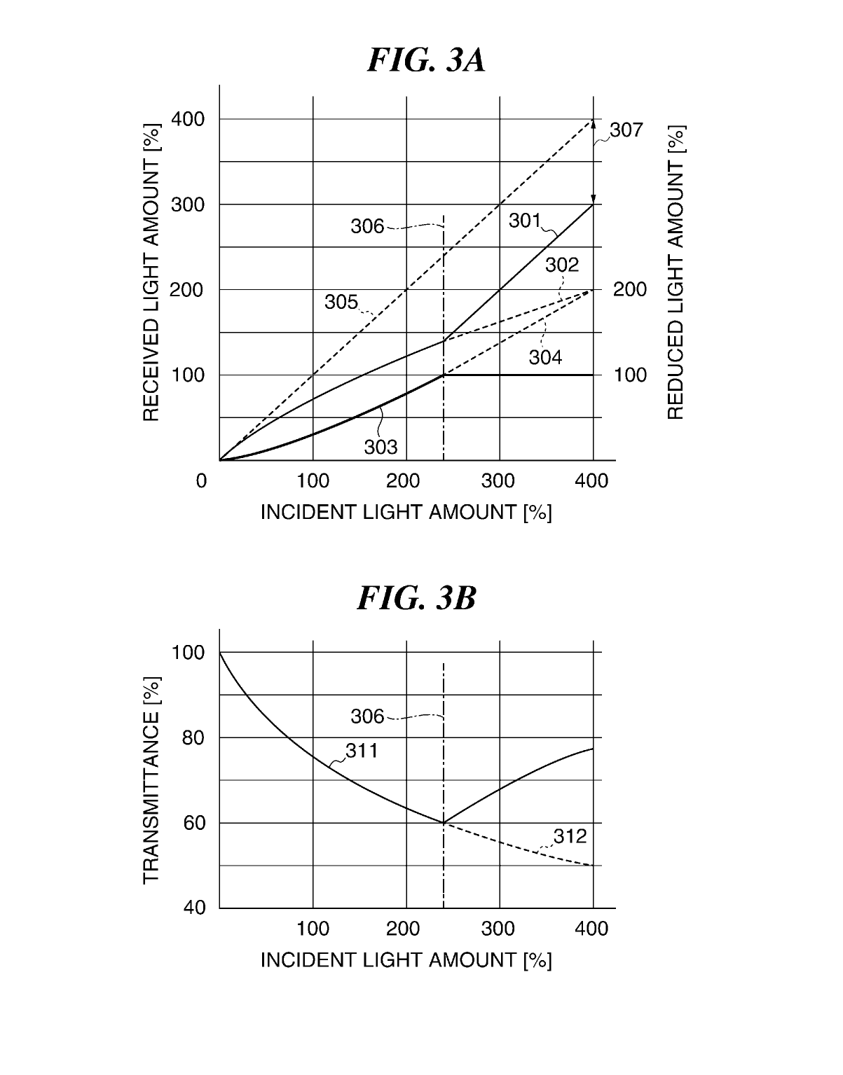

FIG. 3A is a graph showing a relationship between the incident light amount on the physical stop 104 (in percentage with respect to a predetermined value, referred to hereinafter), the received light amount by the image pickup device 105 (in percentage with respect to the predetermined value), and the reduced light amount by the physical stop 104 (in percentage with respect to the predetermined value).

Referring to FIG. 3A, the horizontal axis represents, in percentage with respect to the predetermined value, the incident light amount on the physical stop 104 through the optical unit, and the vertical axis represents, in percentage with respect to the predetermined value, the received light amount by the image pickup device 105 and the reduced light amount by a change in the transmittance of the physical stop 104.

Further, a solid line 301 indicates, in percentage with respect to the predetermined value, the received light amount by the image pickup device 105 corresponding to the incident light amount on the physical stop 104. A broken line 302 indicates, in percentage with respect to the predetermined value, the received light amount by the image pickup device 105 corresponding to the incident light amount on the physical stop 104 in the conventional technique.

Further, a solid line 303 indicates, in percentage with respect to the predetermined value, the reduced light amount corresponding to the incident light amount on the physical stop 104. A broken line 304 indicates, in percentage with respect to the predetermined value, the reduced light amount corresponding to the incident light amount on the physical stop 104 in the conventional technique.

A broken line 305 indicates, in percentage with respect to the predetermined value, the received light amount by the image pickup device 105 corresponding to the incident light amount on the physical stop 104, which is obtained when the transmittance of the physical stop 104 is 100%, at which light is always fully transmitted. That is, the broken line 305 indicates in percentage with respect to the predetermined value, the received light amount by the image pickup device 105 in a case where the amount of reduced light converted to heat by the physical stop 104 is equal to 0.

FIG. 3B is a graph showing a relationship between the incident light amount on the physical stop 104 and the transmittance of the physical stop 104.

Referring to FIG. 3B, a solid line 311 indicates the transmittance of the physical stop 104 with respect to the incident light amount on the physical stop 104 in the present embodiment. Further, a broken line 312 indicates the transmittance of the physical stop 104 with respect to the incident light amount on the physical stop 104 in the conventional technique.

Further, a dashed-dotted line 306 orthogonal to the horizontal axis in FIGS. 3A and 3B indicates the incident light amount (in percentage) at which the reduced light amount NDlos is equal to the predetermined value R. Further, in FIGS. 3A and 3B, a white peak value (maximum value of luminance) of a standard incident light amount on the image pickup device 105 is set as 100% of the incident light amount. In other words, the aforementioned predetermined value corresponds to this white peak value of the standard incident light amount on the image pickup device 105, and as can be understood from the solid line 303, in the present embodiment, the predetermined value is set to be equal to the aforementioned predetermined value R.

In FIGS. 3A and 3B, a description will be given of transmittance change control performed in a left area with respect to the dashed-dotted line 306, i.e. an area in which the incident light amount is small, and the control for protecting the physical stop 104 is not required to be performed.

First, the transmittance of the physical stop 104 is controlled using the equation (1), and as indicated by the solid line 301 in FIG. 3A, the received light amount by the image pickup device 105 changes according to changes in the transmittance of the physical stop 104.

Then, when the incident light amount on the physical stop 104 increases and reaches the dashed-dotted line 306 at which the reduced light amount is equal to the predetermined value, the transmittance change control is changed to one for controlling the transmittance of the physical stop 104 so as to prevent further increase in the reduced light amount.

That is, in FIG. 3A, after the solid line 303 rises to become equal to the reduced light amount 100%, the protection transmittance is calculated by using the equation (5).

As a result, in FIG. 3B, the solid line 311 indicative of the transmittance indicates that since a ratio of the reduced light amount to the incident light amount on the physical stop 104 is relatively reduced in the area in which the reduced light amount indicated by the solid line 303 in FIG. 3A is held equal to 100%, the transmittance shows an increasing tendency.

Therefore, as indicated by the solid line 301 in FIG. 3A, according to an increase in the incident light amount on the physical stop 104 in the right part with respect to the dashed-dotted line 306, the received light amount by the image pickup device 105 also monotonically increases.

The solid line 301 indicative of the received light amount by the image pickup device 105 here is parallel to the broken line 305 indicative of the received light amount by the image pickup device 105 corresponding to the incident light amount on the physical stop 104 when the transmittance of the physical stop 104 is always set to full transmission. This is due to the control of holding constant the reduced light amount.

Note that it is only required in the present embodiment that the above control is performed on a cell-by-cell basis with respect to a change in the transmittance of the physical stop 104.

As described above, in the first embodiment, in a case where the calculated reduced light amount NDlos becomes equal to or more than the predetermined value R set for prevention of a change in the characteristics of the physical stop 104, the transmittance is controlled such that the reduced light amount is made constant.

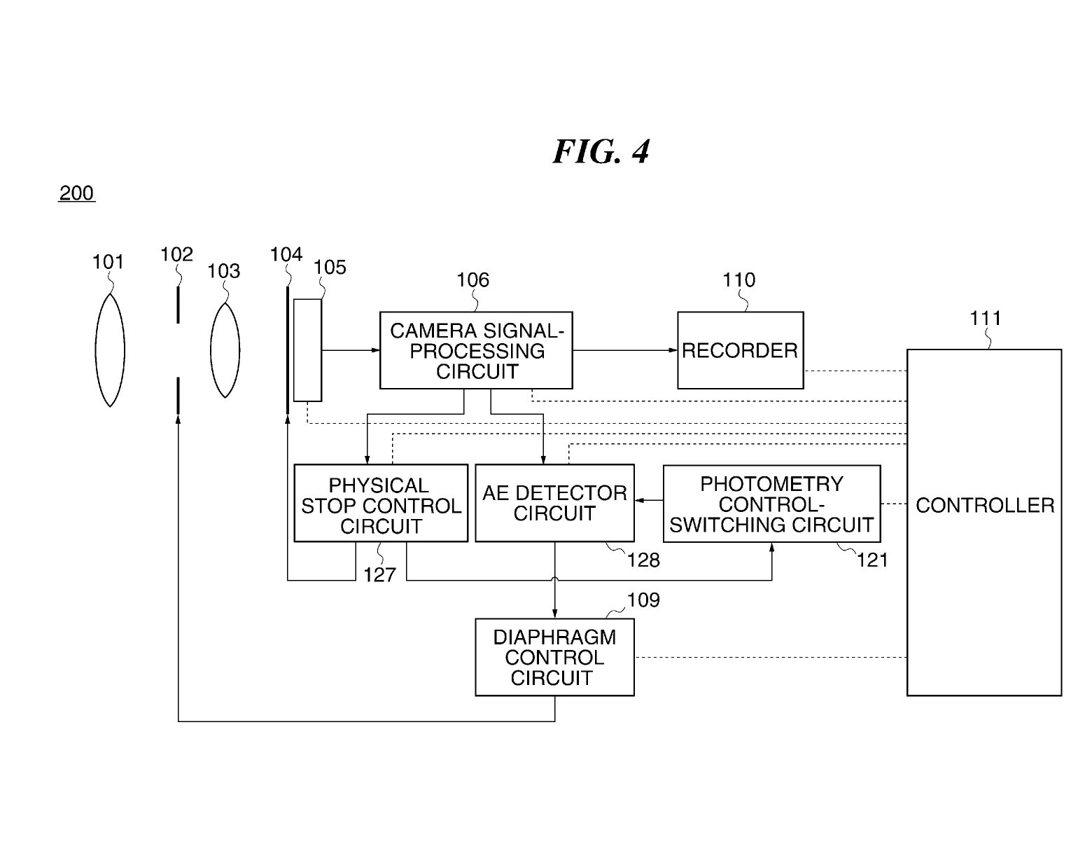

Next, a description will be given of a second embodiment of the present invention. FIG. 4 is a schematic block diagram of an image pickup apparatus 200 according to the second embodiment. Description of components appearing in FIG. 4 corresponding to those appearing in FIG. 1 is omitted.

The image pickup apparatus 200 shown in FIG. 4 has a configuration in which a photometry control-switching circuit 121 is newly added to the image pickup apparatus 100 shown in FIG. 1.

The photometry control-switching circuit 121 is a circuit connected to a physical stop control circuit 127 and an AE detector circuit 128 for changing detection characteristics of the AE detector circuit 128 based on transmittance control information output from the physical stop control circuit 127. Further, in the second embodiment, the diaphragm control circuit 109 corresponds to a diaphragm control unit configured to control the diaphragm 102.

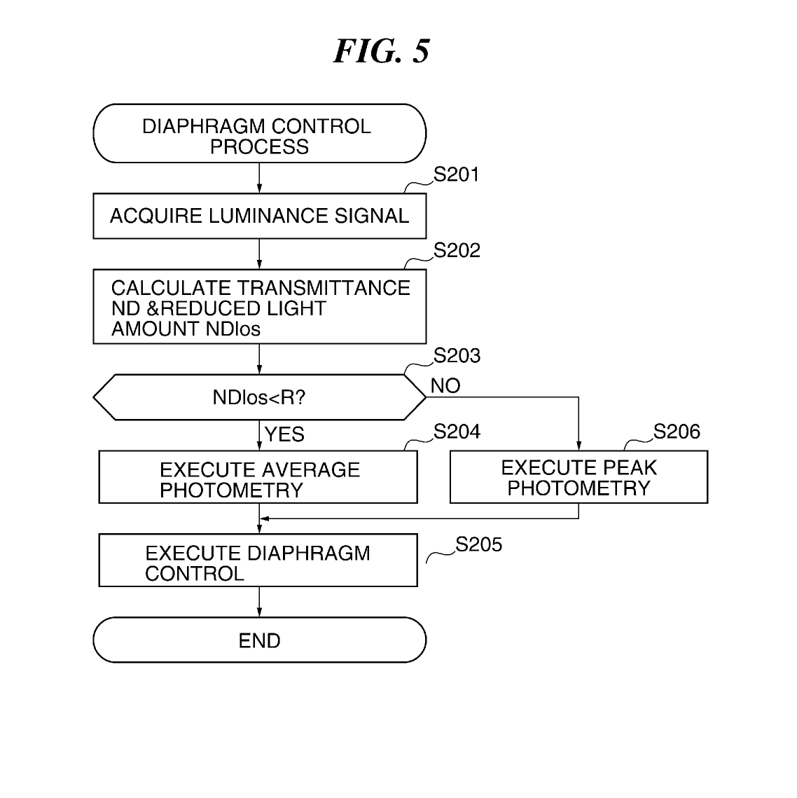

FIG. 5 is a flowchart of a process for controlling the diaphragm 102, which is executed by the controller 111 appearing in FIG. 4.

The process for controlling the diaphragm 102 is repeatedly executed e.g. at synchronization timing of a video vertical synchronization signal.

Referring to FIG. 5, the physical stop control circuit 127 acquires a luminance signal from the camera signal-processing circuit 106 (step S201).

Then, the controller 111 determines the received light amount E by the image pickup device 105 per unit time from the luminance signal acquired by the physical stop control circuit 127, calculates the transmittance ND using the equation (1), and further calculates the reduced light amount NDlos using the equation (4) (step S202).

Then, the controller 111 determines whether or not the reduced light amount NDlos is less than the predetermined value R which is set in advance (step S203). The predetermined value R is a value for determining whether or not the reduced light amount is an amount which has no influence on the change of characteristics even when the reduced light amount is continued which is, in other words, an amount of reduced light converted to heat by the physical stop 104.

If it is determined in the step S203 that the reduced light amount NDlos is less than the predetermined value R (YES to the step S203), the photometry control-switching circuit 121 controls the AE detector circuit 128 such that it performs average photometry (step S204). Further, the controller 111 causes the diaphragm control circuit 109 to control the diaphragm 102 based on the photometry value (step S205), followed by terminating the present process.

On the other hand, if it is determined in the step S203 that the reduced light amount NDlos is not less than the predetermined value R (NO to the step S203), the photometry control-switching circuit 121 controls the AE detector circuit 128 such that it performs peak photometry (step S206). Further, the controller 111 causes the diaphragm control circuit 109 to control the diaphragm 102 based on the photometry value (step S205), followed by terminating the present process.

The above-mentioned peak photometry is performed, in a case where the transmittance of the physical stop 104 is set to a minimum control value, such that the maximum incident light amount on the physical stop 104 is controlled so as to prevent the characteristics of the physical stop 104 from being changed by heat generated by an amount of shielded light.

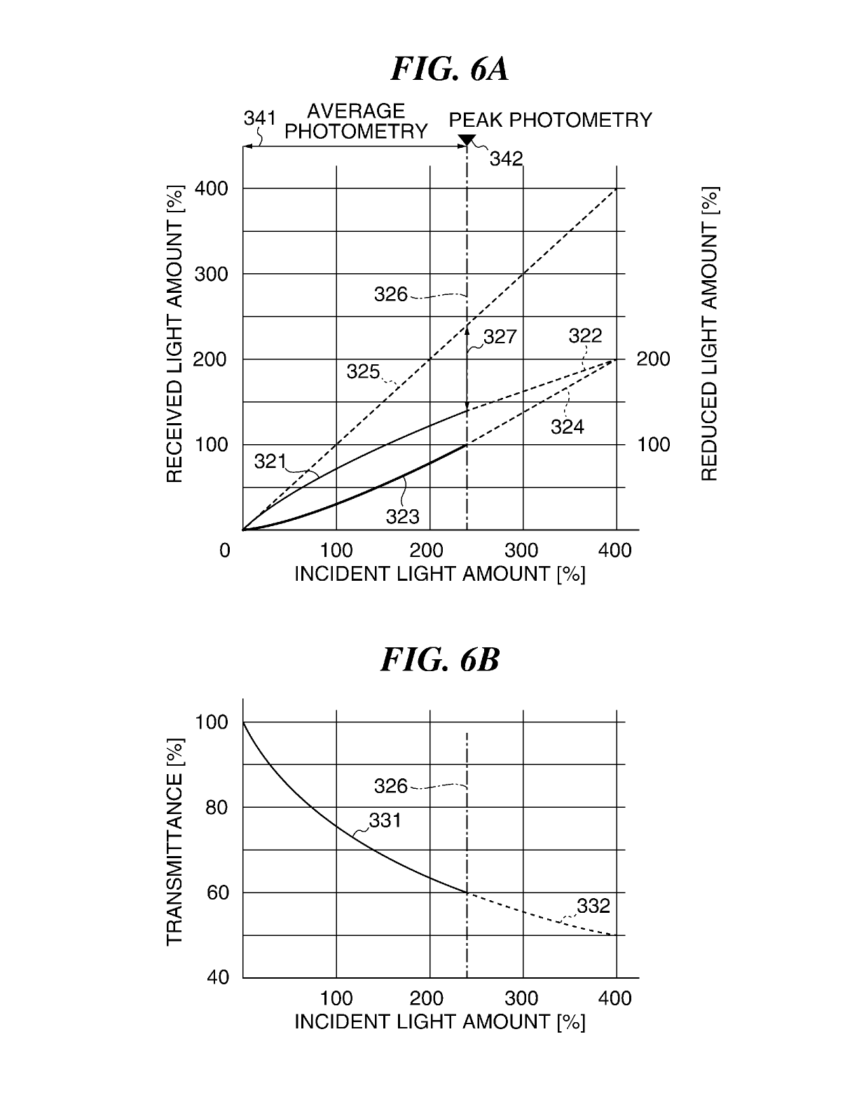

FIG. 6A is a graph showing a relationship between the incident light amount on the physical stop 104 (in percentage with respect to a predetermined value, referred to hereinafter), the received light amount by the image pickup device 105 (in percentage with respect to the predetermined value), and the reduced light amount by the physical stop 104 (in percentage with respect to the predetermined value).

Referring to FIG. 6A, the horizontal axis represents, in percentage with respect to the predetermined value, the incident light amount on the physical stop 104 through the optical unit, and the vertical axis represents, in percentage with respect to the predetermined value, the received light amount by the image pickup device 105 and the reduced light amount by a change in the transmittance of the physical stop 104.

A solid line 321 indicates, in percentage with respect to the predetermined value, the received light amount by the image pickup device 105 corresponding to the incident light amount on the physical stop 104. A broken line 322 indicates, in percentage with respect to the predetermined value, the received light amount by the image pickup device 105 corresponding to the incident light amount on the physical stop 104 in the conventional technique.

A solid line 323 indicates, in percentage with respect to the predetermined value, the reduced light amount corresponding to the incident light amount on the physical stop 104. A broken line 324 indicates, in percentage with respect to the predetermined value, the reduced light amount corresponding to the incident light amount on the physical stop 104 in the conventional technique.

A broken line 325 indicates, in percentage with respect to the predetermined value, the received light amount by the image pickup device 105 corresponding to the incident light amount on the physical stop 104, which is obtained when the transmittance of the physical stop 104 is 100%, at which light is always fully transmitted.

FIG. 6B is a graph showing a relationship between the incident light amount on the physical stop 104 and the transmittance of the physical stop 104.

Further, a dashed-dotted line 326 orthogonal to the horizontal axis in FIGS. 6A and 6B indicates the incident light amount (in percentage) at which the reduced light amount NDlos is equal to the predetermined value R. Further, in FIGS. 6A and 6B, a white peak value (maximum value of luminance) of a standard incident light amount on the image pickup device 105 is set as 100% of the incident light amount. In other words, the aforementioned predetermined value of the incident light amount corresponds to this white peak value of the standard incident light amount on the image pickup device 105, and as can be understood from the solid line 323, in the present embodiment, the predetermined value is set to be equal to the aforementioned predetermined value R.

Referring to FIG. 6B, a solid line 331 indicates the transmittance of the physical stop 104 with respect to the incident light amount on the physical stop 104 in the present embodiment. Further, a broken line 332 indicates the transmittance of the physical stop 104 with respect to the incident light amount on the physical stop 104 in the conventional technique.

In FIGS. 6A and 6B, a description will be given of a left area with respect to the dashed-dotted line 326, i.e. an area in which the incident light amount is small, and the control for protecting the physical stop 104 is not required to be performed.

First, as indicated by the solid line 331 in FIG. 6B, the transmittance control for the physical stop 104 is performed using the equation (1), and as indicated by the solid line 321 in FIG. 6A, the received light amount by the image pickup device 105 changes according to changes in the transmittance of the physical stop 104.

Then, when the incident light amount on the physical stop 104 increases and reaches the dashed-dotted line 326 at which the reduced light amount is equal to the predetermined value, the control for the diaphragm 102 is changed from average photometry, as indicated by reference numeral 341 in FIG. 6A, to peak photometry, as indicated by reference numeral 342 in the same, so as to prevent a further increase in the reduced light amount.

By changing the control for the diaphragm 102 to the peak photometry in which the maximum incident light amount can be limited, neither the incident light amount exceeding the dashed-dotted ling 326 nor the reduced light amount exceeding the dashed-dotted ling 326 is generated.

As described above, by changing the control for the diaphragm 102 to the peak photometry in which the maximum incident light amount can be limited, the control for holding constant the reduced light amount is performed.

Note that a peak value of the received light amount in the peak photometry may be set such that the reduced light amount by the physical stop 104 becomes equal to a light amount corresponding to a difference 327 in FIG. 6A, so as to prevent the characteristics of the physical stop 104 from being changed by the reduced light amount. In other words, the peak value of the received light amount in the peak photometry is a value corresponding to a point of intersection of the solid line 321 and the dashed-dotted line 326.

Further, if the incident light amount lowers after the control has been changed to the peak photometry, the control is changed to the average photometry in the step S205 in FIG. 5.

As described above, in the second embodiment, when the calculated reduced light amount NDlos becomes equal to or more than the predetermined value R set in advance so as to prevent the characteristics of the physical stop 104 from being changed, the diaphragm 102 is controlled such that the reduced light amount is made constant (the protection control is performed).

Next, a description will be given of a third embodiment of the present invention. An image pickup apparatus according to the third embodiment has the same configuration as that of the image pickup apparatus 100 described with reference to FIG. 1, and hence description of components corresponding to those in FIG. 1 is omitted. Further, in the third embodiment, to protect the physical stop 104, protection control for setting the transmittance of the physical stop 104 to 100% is performed.

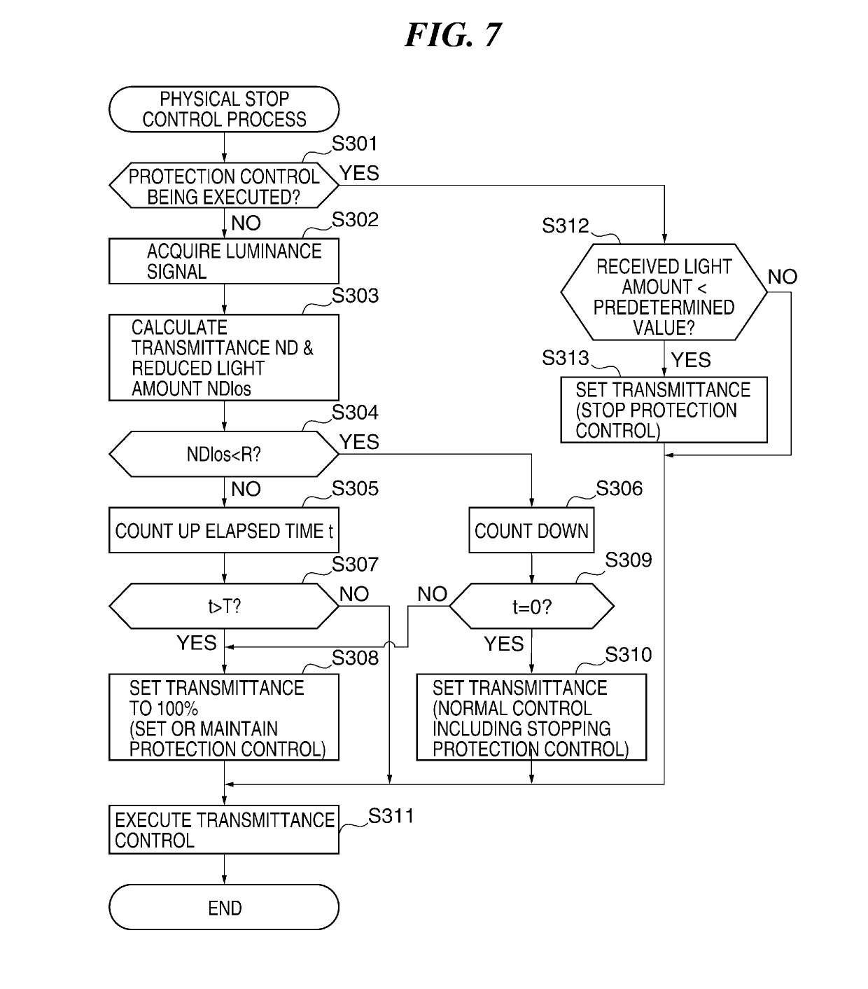

FIG. 7 is a flowchart of a process for controlling the physical stop 104, which is executed by the controller 111 appearing in FIG. 1.

The process for controlling the physical stop 104 is repeatedly executed e.g. at synchronization timing of a video vertical synchronization signal.

Referring to FIG. 7, the controller 111 determines whether or not the above-mentioned protection control in the present embodiment is being executed (step S301). If it is determined in the step S301 that the protection control is not being executed (NO to the step S301), the physical stop control circuit 127 acquires a luminance signal from the camera signal-processing circuit 106 (step S302).

Then, the controller 111 determines the received light amount E by the image pickup device 105 per unit time from the luminance signal acquired by the physical stop control circuit 127, calculates the transmittance ND using the equation (1), and further calculates the reduced light amount NDlos using the equation (4) (step S303).

Then, the controller 111 determines whether or not the reduced light amount NDlos is less than the predetermined value R which is set in advance (step S304). The predetermined value R is a value for determining whether or not the reduced light amount is an amount which has no influence on the change of characteristics even when the reduced light amount is continued which is, in other words, an amount of reduced light converted to heat by the physical stop 104.

If it is determined in the step S304 that the reduced light amount NDlos is not less than the predetermined value R (NO to the step S304), the controller 111 counts up an elapsed time t (step S305), and determines whether or not the elapsed time t exceeds a predetermined time period T (step S307).

If it is determined that the elapsed time t has not exceeded the predetermined time period T (NO to the step S307), the physical stop control circuit 107 controls the transmittance of the physical stop 104 such that it becomes equal to the calculated transmittance ND (step S311), followed by terminating the present process.

On the other hand, if it is determined that the elapsed time t has exceeded the predetermined time period T (YES to the step S307), the controller 111 sets the transmittance to 100% to thereby set protection control (step S308), and the controller 111 causes the physical stop control circuit 107 to control the transmittance of the physical stop 104 such that it becomes equal to 100% (step S311), followed by terminating the present process.

Referring again to the step S304, if it is determined that the reduced light amount NDlos is less than the predetermined value R (YES to the step S304), the controller 111 counts down the elapsed time t while setting a lower limit to 0 (step S306), and determines whether or not the elapsed time t becomes equal to 0 (step S309).

If it is determined that the counted elapsed time t is not equal to 0 (NO to the step S309), the controller 111 proceeds to the step S308 to thereby maintain the setting of 100% of the transmittance (maintain the protection control), whereas if it is determined that the counted elapsed time t is equal to (YES to the step S309), the controller 111 proceeds to a step S310, wherein the controller 111 cancels the setting of 100% of the transmittance (cancel the protection control), and sets the transmittance according to the transmittance change control, described in the first embodiment (step S310). Then, the controller 111 causes the physical stop control circuit 107 to control the transmittance of the physical stop 104 such that it becomes equal to equal to the set transmittance ND (step S311), followed by terminating the present process.

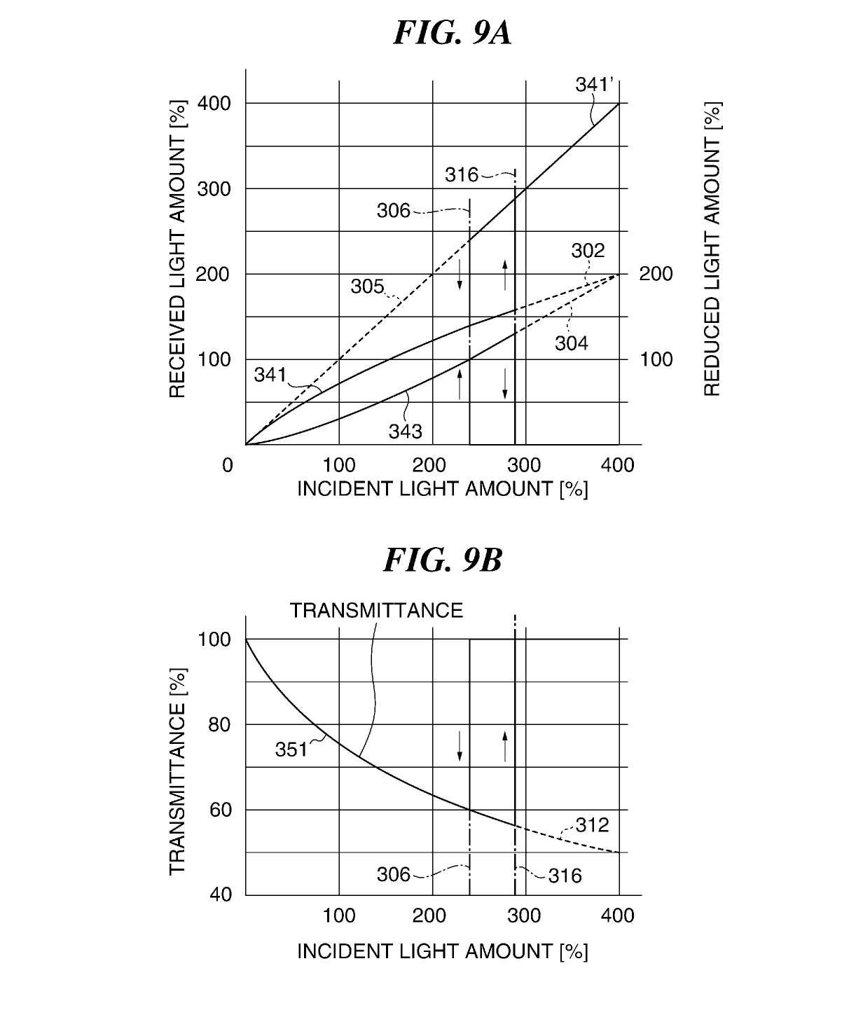

Referring again to the step S301, if the protection control is being executed (YES to the step S301), the controller 111 determines whether or not the received light amount by the image pickup device 105 is less than a predetermined value (step S312). This predetermined value is a received light amount at an intersection point of the dashed-dotted line 306 and the solid line 341 in FIG. 9A.

If it is determined that the received light amount is less than the predetermined value (YES to the step S312), the controller 111 stops the protection control to set the transmittance according to the transmittance change control described in the first embodiment (step S313), and causes the physical stop control circuit 107 to control the transmittance of the physical stop 104 such that it becomes equal to the set transmittance ND (step S311), followed by terminating the present process.

On the other hand, if the received light amount is not less than the predetermined value (NO to the step S309), the controller 111 continues the protection control of the transmittance (step S311), followed by terminating the present process.

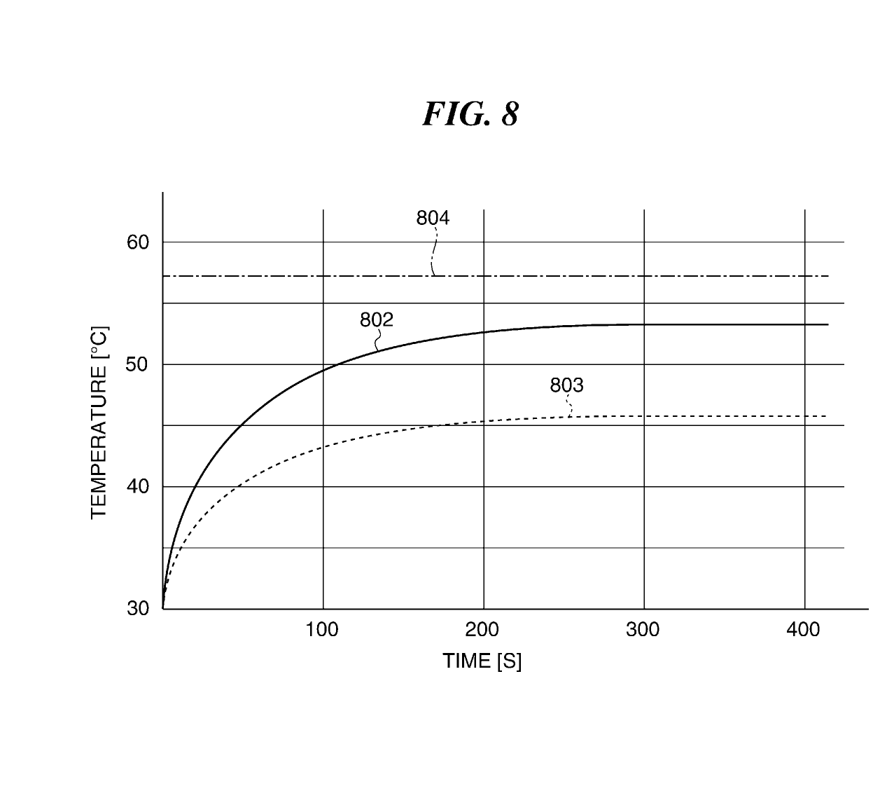

FIG. 8 is a diagram showing changes in the temperature of the physical stop 104 appearing in FIG. 1.

Referring to FIG. 8, a broken line 803 indicates changes in the temperature, caused by absorbing light in a state in which the transmittance of the physical stop 104 is the lowest. Further, a solid line 802 indicates changes in the temperature, caused when photographing an object having a large difference in luminance, such as an object forming an image on the physical stop 104 such that the temperature in the center of a high luminance part thereof becomes the maximum.

Further, a dashed-dotted line 804 indicative of approximately 57 degrees indicates an upper limit below which heat generated by light absorbance by the physical stop 104 does not cause changes in the characteristics of the physical stop 104.

As indicated by the solid line 802 and the broken line 803, the temperature has a tendency to rapidly rise first, but gradually become moderate.

FIG. 9A is a graph showing a relationship between the incident light amount on the physical stop 104 (in percentage with respect to a predetermined value, referred to hereinafter), the received light amount by the image pickup device 105 (in percentage with respect to the predetermined value), and the reduced light amount by the physical stop 104 (in percentage with respect to the predetermined value).

Referring to FIG. 9A, the horizontal axis represents, in percentage with respect to the predetermined value, the incident light amount on the physical stop 104 through the optical unit, and the vertical axis represents, in percentage with respect to the predetermined value, the received light amount by the image pickup device 105 and the reduced light amount by a change in the transmittance of the physical stop 104.

Further, a solid line 341 indicates, in percentage with respect to the predetermined value, the received light amount by the image pickup device 105 corresponding to the incident light amount on the physical stop 104. A broken line 302 indicates, in percentage with respect to the predetermined value, the received light amount by the image pickup device 105 corresponding to the incident light amount on the physical stop 104 in the conventional technique.

Further, a solid line 343 indicates, in percentage with respect to the predetermined value, the reduced light amount corresponding to the incident light amount on the physical stop 104. A broken line 304 indicates, in percentage with respect to the predetermined value, the reduced light amount corresponding to the incident light amount on the physical stop 104 in the conventional technique.

A broken line 305 indicates, in percentage with respect to the predetermined value, the received light amount by the image pickup device 105 corresponding to the incident light amount on the physical stop 104, which is obtained when the transmittance of the physical stop 104 is 100%, at which light is always fully transmitted. That is, the broken line 305 indicates, in percentage with respect to the predetermined value, the received light amount by the image pickup device 105 in a case where the amount of reduced light converted to heat by the physical stop 104 is equal to 0.

FIG. 9B is a graph showing a relationship between the incident light amount on the physical stop 104 and the transmittance of the physical stop 104.

Referring to FIG. 9B, a solid line 351 indicates the transmittance of the physical stop 104 with respect to the incident light amount on the physical stop 104 in the present embodiment. Further, a broken line 312 indicates the transmittance of the physical stop 104 with respect to the incident light amount on the physical stop 104 in the conventional technique.

Further, a dashed-dotted line 306 orthogonal to the horizontal axis in FIGS. 9A and 9B indicates the incident light amount (in percentage) at which the reduced light amount NDlos is equal to the predetermined value R. Further, in FIGS. 9A and 9B, a white peak value (maximum value of luminance) of a standard incident light amount on the image pickup device 105 is set as 100% of the incident light amount. In other words, the aforementioned predetermined value of the incident light amount corresponds to this white peak value of the standard incident light amount on the image pickup device 105, and as can be understood from the solid line 343, in the present embodiment, the predetermined value is set to be equal to the aforementioned predetermined value R.

In FIGS. 9A and 9B, a description will be given of transmittance change control performed in a left area with respect to the dashed-dotted line 306, i.e. an area in which the incident light amount is small, and the control for protecting the physical stop 104 is not required to be performed.

First, the transmittance of the physical stop 104 is controlled using the equation (1), and as indicated by the solid line 341 in FIG. 9A, the received light amount by the image pickup device 105 changes according to changes in the transmittance of the physical stop 104.

Then, when the incident light amount on the physical stop 104 increases and reaches the dashed-dotted line 306, the count-up of elapsed time is started, and when the elapsed time exceeds the predetermined time period T, and the incident light amount has reached a dashed-dotted line 316, the transmittance of the physical stop 104 is set to 100% as shown in FIG. 9B. Note that before the incident light amount reaches the dashed-dotted line 316, the control for adjusting the incident light amount by controlling the diaphragm 102 according to an incident light amount on the image pickup device 105 is performed, and hence the opening diameter of the diaphragm 102 is narrowed so as to adjust the incident light amount on the image pickup device 105 even when the object light amount increases. This prevents an increase in the transmittance of the physical stop 104.

By setting the transmittance of the physical stop 104 to 100%, as shown in FIG. 9A, the received light amount by the image pickup device 105 becomes equal to a value indicated by a solid line 341′ as an extension of the broken line 305. After that, when the incident light amount decreases to reach the value indicated by the dashed-dotted line 306, the transmittance control is switched to the transmittance change control, and hence the transmittance is reduced again (in the vicinity of 60% in the example illustrated FIG. 9B).

As a result, as shown in FIG. 9A, the received light amount by the image pickup device 105 becomes equal to the value indicated by the solid line 341 (including the solid line 341′).

In the graphs shown in FIGS. 9A and 9B, assuming that the incident light amount indicated by the dashed-dotted line 306 is 240%, and an optical luminance occupying area (black occupying area) where a shielded light amount 100% of the physical stop 104 is maintained at the time satisfies the equation “high luminance-occupying area+black occupying area=whole area”, the high luminance-occupying area is calculated based on the following equation:

(luminance 240%×high luminance occupying area+luminance 0%×black occupied area)/whole area=50%

From the above equation, the high luminance-occupying area=20.8% is calculated, and hence by setting an object condition such that the high luminance-occupying area is set to an area slightly smaller than 20.8% of the whole area, and the other area is set to the black occupying area, it is possible to obtain temperature change characteristics in which the maximum temperature indicated by the solid line 802 in FIG. 8 is assumed. The predetermined value R used in the step S304 in FIG. 7 is set with reference to the solid line 802.

The object condition that can match the solid line 802 is determined as described above, and hence the temperature of the physical stop 104 never becomes so high as to adversely affect the physical stop 104, and for example, the temperature of the physical stop 104 changes following a characteristic curve indicated by the broken line 803 in FIG. 8 or the like.

Therefore, even when the control for protecting the physical stop 104 is delayed by the predetermined time period T, much heat as will adversely affect the transmittance characteristics of the physical stop 104 is prevented from being generated.

Through this control, by setting the transmittance to 100% for protection of the physical stop 104, no amount of heat comes to be generated, whereby it can be expected that the temperature is rapidly lowered by heat dissipation.

As described above, in the third embodiment, when the predetermined time period T elapses after the calculated reduced light amount NDlos becomes not less than the predetermined value R set in advance so as to prevent the characteristics of the physical stop 104 from being changed, the transmittance of the physical stop 104 is controlled to 100%.

Further, in the third embodiment, when the received light amount by the image pickup device 105 becomes less than the predetermined value after the transmittance of the physical stop 104 is controlled to 100%, the transmittance is controlled according to the received light amount.

Further, in any of the embodiments, when the reduced light amount NDlos is less than the predetermined value R set in advance so as to prevent the characteristics of the physical stop 104 from being changed, the transmittance is controlled according to the received light amount by the image pickup device 105. More specifically, the transmittance is controlled such that it is reduced in proportion to the received light amount.

As described above, according to the embodiments, the characteristics of the physical stop are prevented from being changed by heat generated by light attenuation by the physical stop, whereby it is possible to prevent light attenuation characteristics and response characteristics of the physical stop from being changed, and further prevent the physical stop from being damaged due to temperature rise.

As described above, according to the embodiments, a reduced light amount by the physical stop 104, by which is reduced the incident light amount on the image pickup device 105 from the optical unit, is calculated, and the transmittance of the physical stop is controlled using the calculated reduced light amount NDlos. That is, the transmittance of the physical stop is controlled such that the characteristics of the physical stop are not changed by heat generated due to absorption of light incident from the optical unit by the physical stop, which makes it possible to prevent the characteristics of the physical stop from being changed.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-131611 filed Jun. 24, 2013, which is hereby incorporated by reference herein in its entirety.

What is claimed is:

1. An image pickup apparatus comprising:
an image pickup device;
an optical unit configured to form an object image on said image pickup device;
a transmittance changing member that is provided between said optical unit and said image pickup device, and is configured to be capable of changing a transmittance with which said transmittance changing member transmits therethrough light to be incident on said image pickup device from said optical unit;
a calculation unit configured to calculate a reduced light amount by which the light to be incident on said image pickup device from said optical unit is reduced by said transmittance changing member; and
a control unit configured to control the transmittance of said transmittance changing member using the reduced light amount calculated by said calculation unit such that heat generated by said transmittance changing member absorbing light incident thereon from said optical unit does not cause a change in characteristics of said transmittance changing member beyond an acceptable level.

2. The image pickup apparatus according to claim 1, wherein when the reduced light amount calculated by said calculation unit becomes not smaller than a predetermined value set in advance so as to prevent the change in the characteristics of said transmittance changing member beyond the acceptable level from being caused, said control unit controls the transmittance such that the reduced light amount is made constant.

3. The image pickup apparatus according to claim 1, wherein when a predetermined time period elapses after the reduced light amount calculated by said calculation unit has become not smaller than a predetermined value set in advance so as to prevent the change in the characteristics of said transmittance changing member beyond the acceptable level from being caused, said control unit controls the transmittance to 100%, and
wherein when a received light amount by said image pickup device becomes less than a predetermined value after the transmittance of the transmittance changing member has been controlled to 100%, said control unit controls the transmittance according to the received light amount.

4. The image pickup apparatus according to claim 1, wherein when the reduced light amount calculated by said calculation unit is less than a predetermined value set in advance so as to prevent the change in the characteristics of said transmittance changing member beyond the acceptable level from being caused, said control unit controls the transmittance according to a received light amount by said image pickup device.

5. An image pickup apparatus comprising:
an image pickup device;
an optical unit configured to form an object image on said image pickup device;
a diaphragm configured to limit an amount of incident light;
a transmittance changing member that is provided between said optical unit and said image pickup device, and is configured to be capable of changing a transmittance with which said transmittance changing member transmits therethrough light to be incident on said image pickup device from said optical unit;
a calculation unit configured to calculate a reduced light amount by which the light to be incident on said image pickup device from said optical unit is reduced by said transmittance changing member; and
a diaphragm control unit configured to control, when the reduced light amount calculated by said calculation unit becomes not smaller than a predetermined value set in advance so as to prevent a change in characteristics of said transmittance changing member beyond an acceptable level from being caused by said transmittance changing member absorbing light incident thereon from said optical unit, said diaphragm such that the reduced light amount is made constant.

6. A method of controlling an image pickup apparatus including an image pickup device, an optical unit configured to form an object image on the image pickup device, and a transmittance changing member that is provided between the optical unit and the image pickup device, and is configured to be capable of changing a transmittance with which the transmittance changing member transmits therethrough light to be incident on the image pickup device from the optical unit,
the method comprising:
calculating a reduced light amount by which the light to be incident on the image pickup device from the optical unit is reduced by the transmittance changing member; and
controlling the transmittance of the transmittance changing member using the reduced light amount calculated by said calculating such that heat generated by the transmittance changing member absorbing light incident thereon from the optical unit does not cause a change in characteristics of the transmittance changing member beyond an acceptable level.

7. A method of controlling an image pickup apparatus including an image pickup device, an optical unit configured to form an object image on the image pickup device, a diaphragm configured to limit an amount of incident light, and a transmittance changing member that is provided between the optical unit and the image pickup device, and is configured to be capable of changing a transmittance with which the transmittance changing member transmits therethrough light to be incident on the image pickup device from the optical unit,
the method comprising:
calculating a reduced light amount by which the light to be incident on the image pickup device from the optical unit is reduced by the transmittance changing member; and
controlling, when the reduced light amount calculated by said calculating becomes not smaller than a predetermined value set in advance so as to prevent a change in characteristics of the transmittance changing member beyond an acceptable level from being caused by the transmittance changing member absorbing light incident thereon from the optical unit, the diaphragm such that the reduced light amount is made constant.

8. A non-transitory computer-readable storage medium storing a computer-executable program for executing a method of controlling an image pickup apparatus including an image pickup device, an optical unit configured to form an object image on the image pickup device, and a transmittance changing member that is provided between the optical unit and the image pickup device, and is configured to be capable of changing a transmittance with which the transmittance changing member transmits therethrough light to be incident on the image pickup device from the optical unit:
wherein the method comprises:
calculating a reduced light amount by which the light to be incident on the image pickup device from the optical unit is reduced by the transmittance changing member; and
controlling the transmittance of the transmittance changing member using the reduced light amount calculated by said calculating such that heat generated by the transmittance changing member absorbing light incident thereon from the optical unit does not cause a change in characteristics of the transmittance changing member beyond an acceptable level.

9. A non-transitory computer-readable storage medium storing a computer-executable program for executing a method of controlling an image pickup apparatus including an image pickup device, an optical unit configured to form an object image on the image pickup device, a diaphragm configured to limit an amount of incident light, and a transmittance changing member that is provided between the optical unit and the image pickup device, and is configured to be capable of changing a transmittance with which the transmittance changing member transmits therethrough light to be incident on the image pickup device from the optical unit,
wherein the method comprises:
calculating a reduced light amount by which the light to be incident on the image pickup device from the optical unit is reduced by the transmittance changing member; and
controlling, when the reduced light amount calculated by said calculating becomes not smaller than a predetermined value set in advance so as to prevent a change in characteristics of the transmittance changing member beyond an acceptable level from being caused by the transmittance changing member absorbing light incident thereon from the optical unit, the diaphragm such that the reduced light amount is made constant.
